(19) United States
(12) Patent Application Publication
(10) Pub. No.: US 2026/0091405 A1
(43) Pub. Date: Apr. 2, 2026

(54) COATING DEVICE

(71) Applicant: TOYOTA JIDOSHA KABUSHIKI KAISHA, Toyota-shi (JP)

(72) Inventor: Yasuhiro SAKASHITA, Nisshin-shi (JP)

(73) Assignee: TOYOTA JIDOSHA KABUSHIKI KAISHA, Toyota-shi (JP)

(21) Appl. No.: 19/211,460

(22) Filed: May 19, 2025

(30) Foreign Application Priority Data
Oct. 2, 2024 (JP) 2024-173347

(51) Int. Cl. B05C 5/02; B05C 11/10

(52) U.S. Cl. CPC B05C 5/0254; B05C 5/0279; B05C 11/10

(57) ABSTRACT

A coating device according to an aspect of the present disclosure includes a coating device for forming a coating film on a base material, the coating device including a slit die including a manifold for storing a coating material, a slit for discharging the coating material, and a land disposed between the manifold and the slit to make the coating material flowing out of the manifold laminar flow, and a diffusion portion disposed in the manifold. The diffusion portion has a plurality of holes through which the coating material passes, and the plurality of holes make the flow rate of the coating material flowing from the manifold to the land uniform in the width direction of the coating device.

### CROSS-REFERENCE TO RELATED APPLICATION

This application claims priority to Japanese Patent Application No. 2024-173347 filed on Oct. 2, 2024. The disclosure of the above-identified application, including the specification, drawings, and claims, is incorporated by reference herein in its entirety.

### BACKGROUND

### 1. Technical Field

The present disclosure relates to a coating device and, for example, relates to a coating device that forms a coating film on a base material.

### 2. Description of Related Art

A general coating device is configured to discharge a coating material that is stored in a manifold of a slit die, from a slit of the slit die, to form a coating film on a base material. At this time, it is preferable that film thickness of the coating film be uniformly formed in a width direction of the coating device.

For example, in a coating device of Japanese Unexamined Patent Application Publication No. 2024-78873 (JP 2024-78873 A), coating material is supplied to a manifold via a branch portion having two branch channels with equal channel distances as each other. Thus, the coating device of JP 2024-78873 A suppresses variance in flow rate distribution of the coating material flowing into the manifold, in the width direction of the coating device, by uniformizing distribution of pressure loss in the branch portion.

### SUMMARY

The present applicant found the following problem. The coating device of JP 2024-78873 A cannot uniformize flow rate of the coating material in the width direction of the coating device, in a path from the manifold to the slit. Accordingly, in the coating device of JP 2024-78873 A, uniformizing film thickness of coating film in the width direction of the coating device is difficult.

The present disclosure provides a coating device that is capable of uniformizing film thickness of coating film in a width direction of the coating device.

A coating device according to an aspect of the present disclosure is a coating device for forming a coating film on a base material, the coating device including a slit die that includes a manifold for storing a coating material, a slit for discharging the coating material, and a land that is disposed between the manifold and the slit to cause a laminar flow of the coating material flowing out of the manifold, and
a diffusion portion that is disposed in the manifold, in which
the diffusion portion includes a plurality of holes through which the coating material passes, and
the holes uniformize a flow rate of the coating material flowing from the manifold into the land in a width direction of the coating device.

In the coating device described above, preferably, an inflow port, from which the coating material flows into the manifold, is disposed in the manifold, and the holes are disposed such that an opening ratio increases as distance from the inflow port increases.

In the coating device described above, preferably, the diffusion portion is a plate member in which the holes are opened, and the diffusion portion is disposed so as to be inclined more toward a bottom side of the manifold, further from the inflow port toward a slit side.

In the coating device described above, preferably, a plurality of the diffusion portion is disposed at intervals from the inflow port toward the slit side, and the holes of the diffusion portions are disposed not overlapping each other, as viewed from the inflow port toward the slit side.

According to the present disclosure, a coating device can be realized that is capable of uniformizing film thickness of coating film in a width direction of the coating device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a coating device according to an embodiment;

FIG. 2 is a perspective view showing a first die of the coating device according to the embodiment;

FIG. 3 is a perspective view showing a shim of the coating device according to the embodiment;

FIG. 4 is a perspective view showing a second die of the coating device of the embodiment; and

FIG. 5 is a perspective view illustrating a first diffusion portion and a second diffusion portion of the coating device according to the embodiment.

### DETAILED DESCRIPTION OF EMBODIMENTS

Hereinafter, specific embodiments to which the present disclosure is applied will be described in detail with reference to the drawings. However, the present disclosure is not limited to the following embodiments. Also, for clarity of explanation, the following description and the drawings are simplified as appropriate.

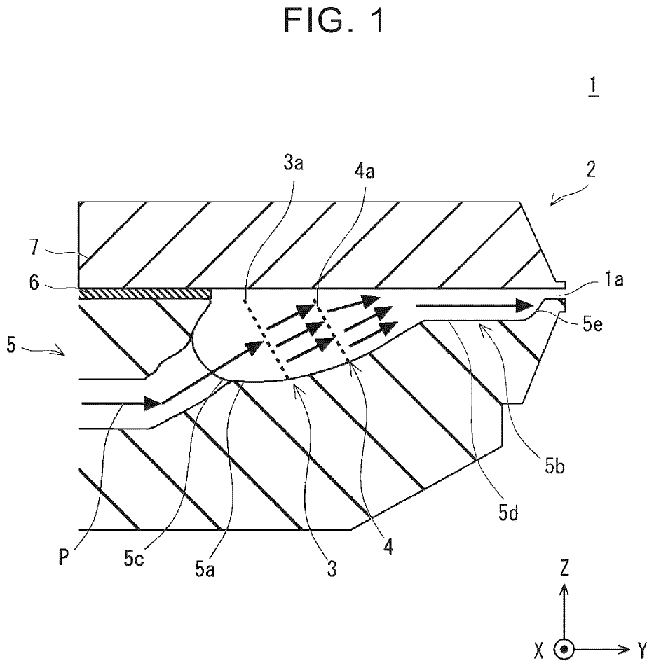

First, the configuration of the coating device 1 of the present embodiment will be described. FIG. 1 is a cross-sectional view showing a coating device according to the present embodiment. In the following description, for clarity of description, a three-dimensional (XYZ) coordinate system will be used.

Here, for example, the X-axis+side is the right side of the coating device, the X-axis-side is the left side of the coating device, the Y-axis+side is the front side of the coating device, the Y-axis-side is the rear side of the coating device, the Z-axis+side is the upper side of the coating device, and the Z-axis-side is the lower side of the coating device.

The coating device 1 is suitable, for example, for forming a thriller coating film used for an electrode of a power storage cell, which is a representative example of the coating material P, on an electrode foil made of aluminum or the like, which is a representative example of the base material. As shown in FIG. 1, the coating device 1 includes a slit die 2, a first diffusion portion 3, and a second diffusion portion 4, and a slit 1a for discharging the coating material P is disposed at the Y-axis+side end portion of the coating device 1. The slit 1a extends in the X-axis direction.

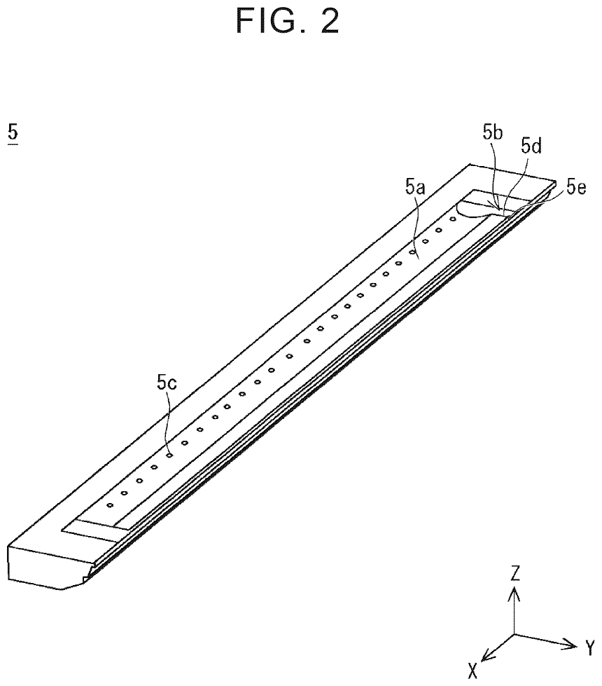

As shown in FIG. 1, the slit die 2 includes a first die 5, a shim 6, and a second die 7. FIG. 2 is a perspective view showing a first die of the coating device of the present embodiment. As shown in FIGS. 1 and 2, the first die 5 is a blocking member extending in the X-axis direction, and includes a manifold 5a and a land 5b.

The manifold 5a is a recessed portion for storing the coating material P, and is disposed on the Z-axis+side surface of the first die 5 as shown in FIGS. 1 and 2. The manifold 5a is, for example, substantially semi-teardrop-shaped when viewed in the X-axis direction, and extends in the X-axis direction.

That is, as shown in FIG. 1, the surface on the Z-axis-side, which is the bottom surface of the manifold 5a, warps toward the Z-axis+side toward the Y-axis+side. An inflow port 5c into which the coating material P flows is disposed at an end portion of the manifold 5a on the Z-axis-side and at an end portion on the Y-axis-side. The inflow port 5c is, for example, spaced apart in the X-axis direction.

The land 5b is a recessed portion for laminar flow of the coating material P flowing from the manifold 5a, and is disposed between the manifold 5a and the slit 1a of the coating device 1 in the Y-axis direction, as shown in FIG. 1. As shown in FIG. 2, the land 5b is disposed on the Z-axis+side surface of the first die 5 and extends in the X-axis direction with a width dimension substantially equal to the width dimension of the manifold 5a in the X-axis direction.

The land 5b includes, for example, a rectifying portion 5d and a throttle 5e as illustrated in FIGS. 1 and 2. The Y-axis-side end portion on the Z-axis-side surface of the rectifying portion 5d is continuous with the Y-axis-side end portion on the Z-axis-side surface of the manifold 5a.

As shown in FIGS. 1 and 2, for example, the rectifying portion 5d has a substantially rectangular shape that is long in the Y-axis direction when viewed from the X-axis direction. The diaphragm portion 5e has, for example, a substantially right-angled triangular shape having an oblique side inclined toward the Z-axis+side as viewed from the X-axis direction toward the Y-axis+side at an end portion on the Y-axis+side.

As shown in FIGS. 1 and 2, the Y-axis-side end portion on the Z-axis-side surface of the diaphragm portion 5e is continuous with the Y-axis-side end portion on the Z-axis-side surface of the rectifying portion 5d, and the Y-axis-side end portion on the Z-axis-side surface of the diaphragm portion 5e is continuous with the Y-axis-side end portion on the Z-axis-side surface of the slit 1a of the coating device 1. It should be noted that the land 5b may be configured such that the coating material P flowing from the manifold 5a flows into the slit 1a of the coating device 1 in a laminar flow.

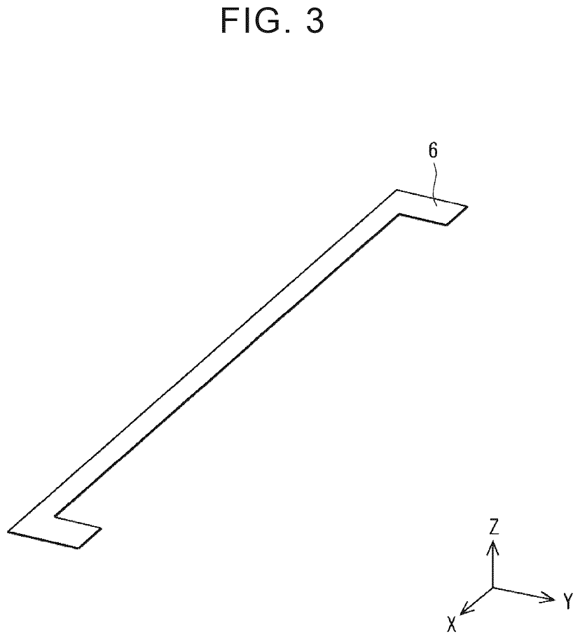

FIG. 3 is a perspective view showing a shim of the coating device of the present embodiment. As shown in FIG. 3, the shim 6 is a substantially C-shaped plate member whose Y-axis+side is opened as viewed from the Z-axis direction, and an opening portion of the shim 6 on the Y-axis+side constitutes a slit 1a of the coating device 1. As shown in FIG. 1, the shim 6 is placed on the Z-axis+side end of the first die 5 so as to surround the manifold 5a and the land 5b of the first die 5 when viewed from the Z-axis.

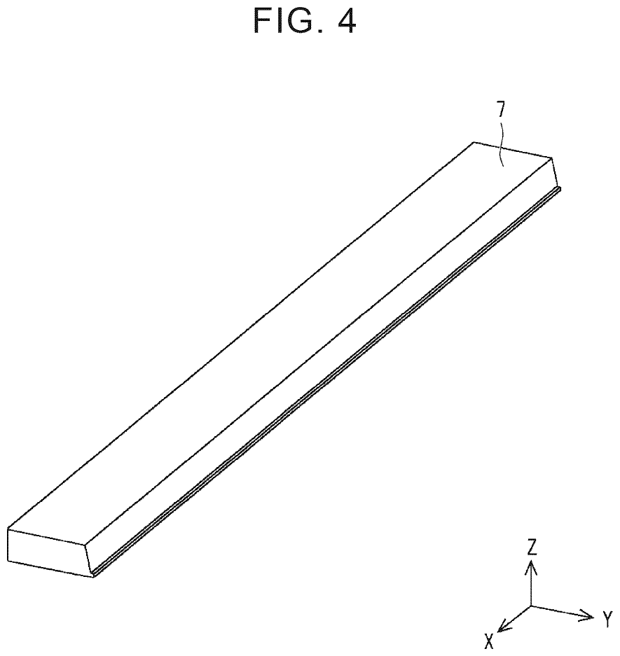

FIG. 4 is a perspective view showing a second die of the coating device of the present embodiment. As shown in FIG. 4, the second die 7 is a block member extending in the X-axis direction, and for example, a surface of the second die 7 on the Z-axis-side is substantially flat. As shown in FIG. 1, the second die 7 is disposed on the Z-axis+side with respect to the first die 5.

As shown in FIG. 1, the second die 7 sandwiches the shim 6 with the first die 5. That is, the second die 7 covers the manifold 5a of the first die 5, the land 5b, and the slit 1a of the coating device 1 from the Z-axis+side.

The first diffusion portion 3 and the second diffusion portion 4 are arranged in order to make the flow rate of the coating material P flowing into the land 5b from the manifold 5a of the slit die 2 substantially uniform along the X-axis. For example, as shown in FIG. 1, the first die 5 is disposed substantially over the entire area of the manifold 5a in the X-axis direction.

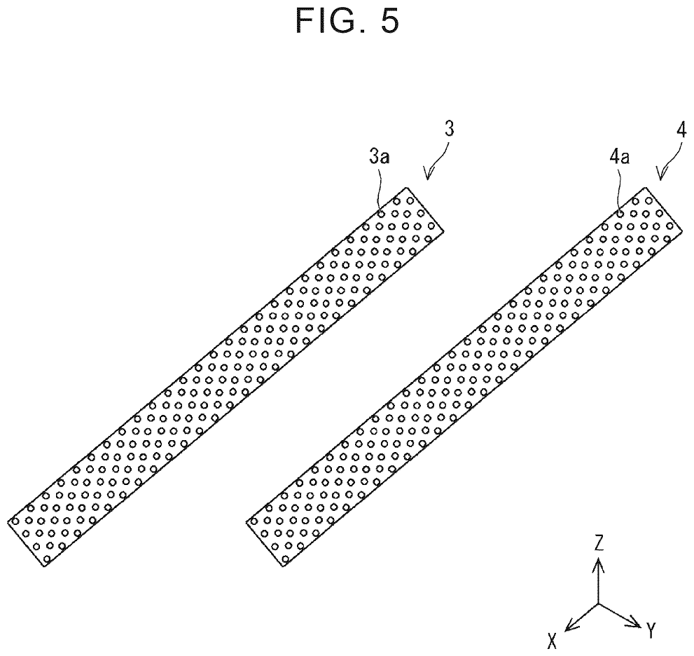

FIG. 5 is a perspective view showing a first diffusion portion and a second diffusion portion of the coating device according to the present embodiment. In FIG. 5, the shapes of the first diffusion portion and the second diffusion portion are illustrated in a simplified manner, and the outer shapes of the first diffusion portion and the second diffusion portion, the shapes of the holes, the arrangement, the size, and the like are not accurately illustrated.

As illustrated in FIG. 5, the first diffusion portion 3 is, for example, a substantially rectangular plate member elongated in the X-axis direction, and includes a plurality of holes 3a. The hole 3a is arranged so that the flow rate of the coating material P can be made substantially uniform along the X-axis when the coating material P flowing from the inflow port 5c of the first die 5 into the manifold 5a passes through the hole 3a. For example, the hole 3a may be arranged such that the aperture ratio increases as the distance from the inflow port 5c of the first die 5 increases.

As shown in FIG. 1, the second diffusion portion 4 is disposed on the Y-axis+side with respect to the first diffusion portion 3, and is, for example, disposed substantially in parallel with the first diffusion portion 3 at an interval from the X-axis direction. As illustrated in FIG. 5, the second diffusion portion 4 is, for example, a substantially rectangular plate member elongated in the X-axis direction, and includes a plurality of holes 4a. The hole 4a is arranged so that the flow rate of the coating material P can be substantially uniformized in the X-axis direction when the coating material P that has passed through the hole 3a of the first diffusion portion 3 passes through the hole 4a.

For example, the hole 4a may be arranged such that the aperture ratio increases as the distance from the inflow port 5c of the first die 5 increases. Further, the hole 4a may be disposed so as not to substantially overlap the hole 3a of the first diffusion portion 3, for example, when viewed from the thickness of the second diffusion portion 4.

Note that the hole 3a of the first diffusion portion 3 and the hole 4a of the second diffusion portion 4 may be any shapes, sizes, and arrangements capable of uniformizing the flow rate of the coating material P flowing into the land 5b from the manifold 5a of the slit die 2 in the X-axis direction.

These first diffusion portion 3 and the second diffusion portion 4, although the detailed function will be described later, as shown in FIG. 1, so that the coating material P flowing into the manifold 5a from the inflow port 5c of the first die 5 flows from the slit 1a toward the slit OOD of the coating device 1, it may be arranged so as to be inclined toward the Z-axis-side toward the Y-axis+side. Here, the first diffusion portion 3 and the second diffusion portion 4 may be fixed to the manifold 5a of the first die 5 by a mechanical fastening means such as a weld means or a bolt.

Next, the flow of the coating material P inside the slit die 2 in the coating device 1 of the present embodiment will be described. When the coating material P flows from the inflow port 5c of the first die 5 to the manifold 5a and passes through the hole 3a of the first diffusion portion 3, the flow rate of the coating material P is substantially uniform along the X-axis.

Then, the coating material P that has passed through the hole 3a of the first diffusion portion 3 passes through the hole 4a of the second diffusion portion 4, so that the flow rate of the coating material P is further substantially uniformized in the X-axis direction. At this time, the hole 4a of the second diffusion portion 4, for example, when viewed from the thickness direction of the second diffusion portion 4, since it is arranged so as not to substantially overlap the hole 3a of the first diffusion portion 3, the flow rate of the coating material P in the X-axis direction it is possible to substantially uniformize by subdividing.

In addition, the first diffusion portion 3 and the second diffusion portion 4 are arranged so as to be inclined toward the Z-axis-side toward the Y-axis+side. Therefore, a flow toward the Z-axis+side toward the Y-axis+side, that is, a flow guided to the slit 1a of the coating device 1 is generated, and it is possible to prevent the bubbles from staying in the Z-axis-side part of the manifold 5a. As a result, it is possible to prevent air bubbles from being discharged together with the coating material P, and to improve coating accuracy.

The coating material P having passed through the first diffusion portion 3 and the second diffusion portion 4 becomes turbulent and flows into the rectifying portion 5d on the land 5b in the first die 5. The coating material P flowing into the rectifying portion 5d of the land 5b in the first die 5 becomes a laminar flow, and is discharged from the diaphragm portion 5e of the coating device 1 through the slit 1a on the land 5b to be applied to the base material.

At this time, since the flow rate of the coating material P is substantially uniform in the X-axis direction by the first diffusion portion 3 and the second diffusion portion 4, the film thickness of the coating film can be substantially uniform in the X-axis direction. Further, since the laminar flow of the coating material P is caused by the rectifying portion 5d of the land 5b in the first die 5, it is possible to suppress the coating material P from being discharged in a turbulent flow, and it is possible to suppress the disturbance of the film thickness of the coating film.

As described above, in the coating device 1 of the present embodiment, since the flow rate of the coating material P is substantially uniform in the X-axis direction by the first diffusion portion 3 and the second diffusion portion 4, the film thickness of the coating film can be substantially uniform in the X-axis direction.

Moreover, in the coating device 1 of the present embodiment, since the coating material P is made to be laminar flow at the rectifying portion 5d on the land 5b in the first die 5, it is possible to prevent the coating material P from being discharged in a turbulent flow, and it is possible to suppress the disturbance of the film thickness of the coating film.

Further, in the coating device 1 of the present embodiment, when a plurality of diffusion portions are provided, the flow rate of the coating material P can be further substantially uniformized in the X-axis direction.

Further, in the coating device 1 of the present embodiment, when the first diffusion portion 3 and the second diffusion portion 4 are arranged so as to incline toward the Z-axis-side as it goes toward the Y-axis+side, a flow toward the Z-axis+side as it goes toward the Y-axis+side, that is, a flow guided to the slit 1a of the coating device 1 is generated, and it is possible to prevent the bubbles from staying in the portion on the Z-axis-side of the manifold 5a. As a result, it is possible to prevent air bubbles from being discharged together with the coating material P, and to improve coating accuracy.

In addition, in the coating device 1 of the present embodiment, when the hole 4a of the second diffusion portion 4 is arranged so as not to substantially overlap the hole 3a of the first diffusion portion 3 when viewed from the thickness direction of the second diffusion portion 4, the flow rate of the coating material P can be subdivided in the X-axis direction to be substantially uniform.

Moreover, it is possible to prevent the flow of the coating material P that has passed through the first diffusion portion 3 from being blocked by the second diffusion portion 4, and it is possible to suppress an increase in the internal pressure of the manifold 5a of the first die 5. Therefore, for example, when the coating material P is intermittently coated, it is possible to prevent the coating material P from being discharged by the internal pressure of the manifold 5a of the first die 5 while the coating material P is stopped.

The coating device 1 of the present embodiment includes the first diffusion portion 3 and the second diffusion portion 4, but may include at least one diffusion portion.

The present disclosure is not limited to the above-described embodiments, and can be appropriately modified without departing from the spirit thereof.

What is claimed is:

1. A coating device for forming a coating film on a base material, the coating device comprising:
a slit die that includes a manifold for storing a coating material, a slit for discharging the coating material, and a land that is disposed between the manifold and the slit to cause a laminar flow of the coating material flowing out of the manifold; and
a diffusion portion that is disposed in the manifold; wherein
the diffusion portion includes a plurality of holes through which the coating material passes, and
the holes uniformize a flow rate of the coating material flowing from the manifold into the land in a width direction of the coating device.

2. The coating device according to claim 1, wherein
an inflow port, from which the coating material flows into the manifold, is disposed in the manifold, and
the holes are disposed such that an opening ratio increases as distance from the inflow port increases.

3. The coating device according to claim 2, wherein
the diffusion portion is a plate member in which the holes are opened, and
the diffusion portion is disposed so as to be inclined more toward a bottom side of the manifold, further from the inflow port toward a slit side.

4. The coating device according to claim 3, wherein
a plurality of the diffusion portion is disposed at intervals from the inflow port toward the slit side, and
the holes of the diffusion portions are disposed not overlapping each other, as viewed from the inflow port toward the slit side.
